(19) United States
(12) Patent Application Publication
(10) Pub. No.: US 2007/0171169 A1
(43) Pub. Date: Jul. 26, 2007

(54) Driving apparatus capable of quickly driving a capacitive load with heat generation reduced and a method therefor

(75) Inventor: Atsushi Hirama, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD.

(21) Appl. No.: 11/653,327

(22) Filed: Jan. 16, 2007

(30) Foreign Application Priority Data
Jan. 24, 2006 (JP) 2006-15482

(51) Int. Cl. G09G 3/36

(52) U.S. Cl. 345/94

(57) ABSTRACT

A liquid crystal display driver is configured so that an external power supply is provided in an area separate from an internal power supply, which is connected to the driver to supply current at a voltage in the range between voltages V1 and V4. Switch signals are supplied from a switching control signal generator to a drive switcher at predetermined periodic intervals. A voltage is appropriately selected from the voltages of internal and external drives by switching between internal and external switchers. In this way, either one of the internal and external power supplies is selected, and the selected power supply is allowed to apply the corresponding voltages to the display loads.

### BACKGROUND OF THE INVENTION

1. Field of the Invention

The present invention relates to an apparatus and a method for driving a display device, and more particularly to an apparatus and a method for driving a liquid crystal display panel for use in a liquid crystal projector, a liquid crystal monitor, etc.

2. Description of the Background Art

For example, a TFT (Thin Film Transistor) type of liquid crystal panel is driven by a driving circuit provided with switches used to temporarily short circuit signal lines, the short-circuiting process being herein called “pre-charging”. The pre-charge process used in such a driving circuit is to temporarily short circuit signal lines, and to provide a capability to supply a signal voltage to a liquid crystal load to charge or discharge the load together with attempting to reduce power consumption. Further, a typical driving circuit uses a two-dot inversion drive to reduce power consumption for driving a load. The two-dot inversion drive is to alternately inverse the polarity of a selection voltage every two horizontal scanning periods of an image signal to be displayed. The two-dot inversion drive has to include a mechanism to degrade display quality and therefore pre-charge sequencing is generally performed every horizontal scanning period.

Japanese Patent Laid-Open Publication No. 95729/1999 discloses a driving method in which the potential of a common electrode is kept constant and the polarity of a selection voltage is alternately inversed every horizontal scanning period. However, short circuiting source lines during a pre-charge period according to the method only causes the potential at a source line to be equalized to the potential of the common electrode. Accordingly, the amount of electrical charge equal to one half of that observed in a case where a pre-charge process is not performed remains and should be accumulated or removed. In this case, an appropriate voltage is applied to the source line to accumulate or remove the corresponding electrical charge. Consequently, reduction in power consumption is not sufficient.

U.S. Patent Application Publication No. US 2005/0083278 A1 to Teraishi discloses a method in which a source line can be driven starting from a predetermined potential generated by a gray-scale voltage generator. According to the conventional method, a potential with which the source line is driven is changed from the potential of a conventional common electrode to the potential generated by the gray-scale voltage generator, thereby reducing power consumption.

However, even if use is made of the above-described conventional driving method, developed taking into account the reduction of power consumption, and when the number of channels to be operated is increased, for example, by a factor of two, and the panel is driven at a higher frame rate, the liquid crystal display driving apparatus increases its power consumption. Accordingly, an apparatus for driving a high-density liquid crystal display generates a large amount of heat and has a problem to increase its temperature up to its allowable, maximum operational temperature. Further, even below the maximum operational temperature, the liquid crystal display driving apparatus is disposed in a position close to the liquid crystal and thus cannot be allowed to operate at the maximum operational temperature. Further, when a liquid crystal panel is driven at a high frame rate, it is desirable for the liquid crystal display driving apparatus to shorten a period of time required for the positive- and negative-going transitions of the drive pulses for driving a liquid crystal load. In the liquid crystal display driving apparatus, the above-stated reduction in positive-going transition time for the apparatus driving a liquid crystal load is in a trade-off relationship with increase in heat generation due to an increase in power consumption.

### SUMMARY OF THE INVENTION

It is an object of the present invention to provide an apparatus for driving a display device capable of quickly driving a liquid crystal load with heat generation reduced, and to provide a driving method therefor.

In accordance with the present invention, a driving apparatus operative in response to gray-scale data supplied for driving display loads corresponding to pixels, comprising a first driver connected to a first power supply for providing a predetermined range of voltages and receiving a gray-scale signal corresponding to the gray-scale data, the first driver applying a voltage corresponding to the gray-scale data to the display load to drive the display load, a second driver acting as a second power supply for applying a plurality of voltages selected appropriately from the predetermined range of voltages to the display load to drive the display load, a switcher for switching between first drive supported by the first driver and second drive supported by the second driver, and a switching controller for generating a switch signal selecting either one of the first and second drives, the second power supply being provided outside a position at which the first power supply is located.

Further, in accordance with the present invention, a driving method for driving display loads corresponding to pixels in response to gray-scale data supplied, comprising the steps of supplying the display loads with a voltage in a predetermined range of voltages from a first power supply providing a voltage in the predetermined range of voltages, supplying the display loads with a plurality of voltages selected appropriately from the predetermined range of voltages from a second power supply provided outside a position at which the first power supply is located, generating, when a voltage is applied to the display load, a switch control signal for discharging or charging the display load depending on whether the voltage is within or outside the selected plurality of voltages, and supplying, if the voltage is within the selected plurality of voltages, an electric power from the second power supply, and if the voltage is outside the selected plurality of voltages, the electric power from the first power supply.

According to the driving apparatus, the second power supply is located in the outside of the first power supply, a switch signal generated by the switching controller is supplied to the drive switcher, either one of the voltages of the first and second drives is selected and applied to the display load, the first drive is prevented from supplying power, and, instead of the first driver, the second driver is used to supply power, thereby reducing power consumed by the first driver. More specifically, instead of the first power supply, the second power supply is used to reduce power consumption, and hence heat generated by the apparatus comprising the first driver is reduced. In this manner, the driving apparatus appropriately selects a voltage to be applied to the display load, thereby allowing the apparatus to quickly charge and discharge a liquid crystal load.

According to the invention, the method for driving display loads comprises providing a first supply for providing a predetermined range of voltages and a second power supply provided in an area separate from the first power supply, allowing the first and second power supplies to provide power to the corresponding display loads, allowing the first power supply to apply a voltage within the predetermined range of voltages, allowing the second power supply to apply a plurality of voltages selected appropriately from the predetermined range of voltages, generating, when a voltage is applied to the display load, a switch control signal for discharging or charging the display load depending on whether the voltage is within or outside the selected plurality of voltages, and in response to the switch control signal, and allowing, if the voltage is within the selected plurality of voltages, the second power supply to provide power, and, if the voltage is outside the selected plurality of voltages, the first power supply to provide power. In this way, the method involves selecting either one of the first and second power supplies and allowing the selected second power supply to provide charge to the display loads, thus preventing the first power supply from providing power. This reduces electrical power consumed by the first power supply. In other words, instead of the first power supply, the second power supply is used to reduce power consumption, and thus heat generated by the apparatus comprising the first power supply is reduced. In this manner, the driving apparatus appropriately selects a voltage to be applied to the display load, thereby allowing the apparatus to quickly charge and discharge a liquid crystal load.

### BRIEF DESCRIPTION OF THE DRAWINGS

The objects and features of the present invention will become more apparent from consideration of the following detailed description taken in conjunction with the accompanying drawings in which:

FIG. 1 is a block diagram showing a schematic configuration of a liquid crystal display driver to which applied is a liquid crystal display driving apparatus of the invention;

FIG. 2 is a circuit diagram showing a configuration of a switching control signal generator shown in FIG. 1;

FIG. 3 is a timing chart useful for understanding the operation of the liquid crystal display driver shown in FIG. 1;

FIG. 4 is a block diagram showing a schematic configuration of a conventional liquid crystal display driver;

FIG. 5 is a timing chart useful for understanding the operation of the liquid crystal display driver shown in FIG. 4;

FIG. 6 is a graph plotting a relationship between voltage versus display data for the liquid crystal display driver shown in FIG. 1; and

FIG. 7 is a circuit diagram showing an alternative configuration of the switching control signal generator shown in FIG. 1.

### DESCRIPTION OF THE PREFERRED EMBODIMENTS

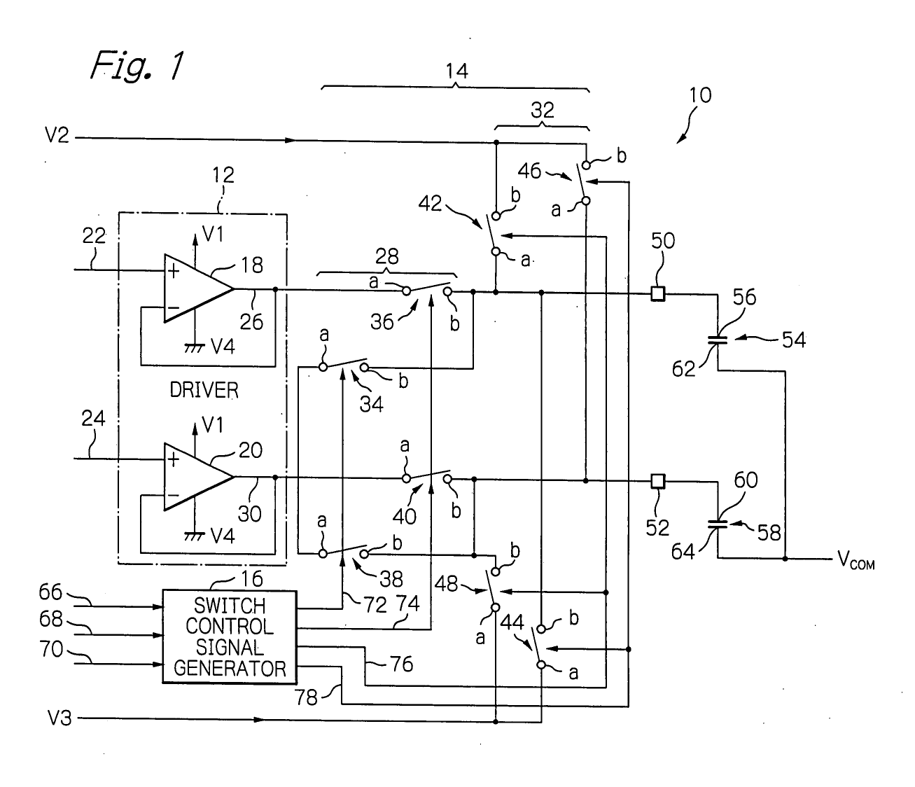

With reference to the accompanying drawings, a preferred embodiment of the driving apparatus according to the present invention will be described in detail. Referring to FIG. 1, in a liquid crystal display driver 10 of the embodiment of the driving apparatus according to the invention, generally, an external power supply, not shown, is provided outside the position in which an internal power supply is located, the internal power supply is connected to a driver 12 for supplying current at a voltage in the range between voltages V1 and V4, and a switching control signal generator 16 supplies switch signals 72 to 78 to a drive switcher 14 at predetermined periodic intervals, the drive switcher 14 switching itself between internal and external switch sections 28 and 32 to select appropriate one of the drive voltages supported by the internal and external power supplies to apply the thus selected voltage to liquid crystal loads 54 and 58, thus preventing the driver 12 acting as an internal drive from supplying power, and using, instead of the internal drive, an external drive to thereby reduce power consumed by the internal drive. In other words, instead of the internal power supply, the external power supply is used to reduce power consumption and hence heat generated by the apparatus comprising the internal power supply. In this manner, the driving apparatus appropriately selects a voltage to be applied to the liquid crystal display load, thereby allowing the apparatus to quickly charge and discharge the liquid crystal display load.

In the instant illustrative embodiment, the driving apparatus of the invention is applied to the liquid crystal display driver 10. Parts or elements not directly pertinent to understanding the invention are omitted from the drawings and description. In the descriptive portion of the application, signals are designated with reference numerals specifying connections on which they appear.

As shown in FIG. 1, the liquid crystal driver 10 includes a driver 12, a drive switcher 14, and a switching control signal generator 16, which are interconnected as illustrated. The liquid crystal display driver 10 is capable of driving a liquid crystal cell of a liquid crystal display panel. The liquid crystal cell includes a storage capacitor.

Note that the liquid crystal display driver 1 is adapted to receive gray scale or gradation signals 22 and 24 corresponding to pixel data representative of an image. The gray scale signals 22 and 24 are produced in analog form, and gray-scale data is produced from the gray scale signal corresponding to supplied pixel data. In order to receive the gray scale signals 22 and 24, the liquid crystal driver 10 is provided on its input with latch circuits and digital-to-analog (D/A) converters, both not shown. The latch circuit is adapted to latch the gray scale or gradation data and output the latched gray scale data to the D/A converter. The D/A converter outputs the supplied gray-scale data in the form of analog signals, i.e., the gray scale signals 22 and 24, to the driver 12.

The driver 12 receives the gray scale signals 22 and 24. The driver circuit 12 of the illustrative embodiment includes operational amplifiers 18 and 20. In the illustrative embodiment, at least the driver 12 may be encapsulated in an LSI (Large-Scale Integration) package, and the external power supply, not specifically shown, is provided outside the package. In the illustrative embodiment, the driver 12 is fed by the internal power supply. The liquid crystal display driver 10 is operated in the voltage ranges respectively dedicated by the internal and external power supplies, which will be described later.

The one operational amplifier 18, functioning as the internal power supply, is connected to voltage V1 and reference or ground potential V4. The operational amplifier 18 feeds an output signal 26 back to the inverting terminal (−) of the operational amplifier 18, and outputs the signal to an internal switcher 28 of the drive switcher 14. The other operational amplifier 20 is connected in the same manner as the operational amplifier 18 and outputs an output signal 30 to the internal switcher 28. The operational amplifiers 18 and 20 output data signals of opposite polarities with respect to a common voltage in the liquid crystal display.

The drive switcher 14 has the internal switcher 28 and an external switcher 32 for allowing the liquid crystal display driver 10 to use capacitive charge sharing between pixels. The internal switcher 28 includes two switches connected to a single operational amplifier. The internal switcher 28 includes switches 34 and 36 connected to the one operational amplifier 18, and switches 38 and 40 connected to the other operational amplifier 20. Also, the external switcher 32 includes two switches connected to a single operational amplifier. The external switcher 32 includes switches 42 and 44 connected to the one operational amplifier 18, and switches 46 and 48 connected to the other operational amplifier 20. The switches 36 through 48 present a low resistance in their conducting state.

Various connection possibilities of the switches 36 to 48 will be given. The switches 34 and 38 have terminals “a” connected together. Further, the switch 36 has its terminal “a” connected to receive an output signal 26 from the operational amplifier 18, and the switch 40 has its terminal “a” connected to receive an output signal 30 from the operational amplifier 20. Terminals “b” of the switches 36, 34, and a terminal “a” of the switch 42 and a terminal “b” of the switch 44 are connected together and also to a terminal 50 of the liquid crystal panel. Likewise, terminals “b” of the switches 40, 38, and a terminal “b” of the switch 48 and a terminal “a” of the switch 46 are connected together and also to a terminal 52 of the liquid crystal panel.

The switches 42 and 46 have terminals “b” connected to the external power supply, not shown, for supplying voltage V2. Further, the switches 44 and 48 have the terminal “a” thereof connected to the external power supply, not shown, for supplying voltage V3.

The liquid crystal panel to be driven has a capacitive load, i.e. a liquid crystal load. The terminal 50 is connected to one end 56 of a load 54 and the terminal 52 is connected to one end 60 of a load 58. The loads 54 and 58 have respective other ends 62 and 64 connected in common.

The switch control signal generator 16 is capable of generating a switch signal for use in controlling the switching state of the switches 36 to 48. The switch control signal generator 16 is adapted to receive load signals 66 and 68, and a polarity or sign signal 70. The switch control signal generator 16 is adapted to generate switch signals 72 to 78 based on the load signals 66 and 68, and the polarity signal 70.

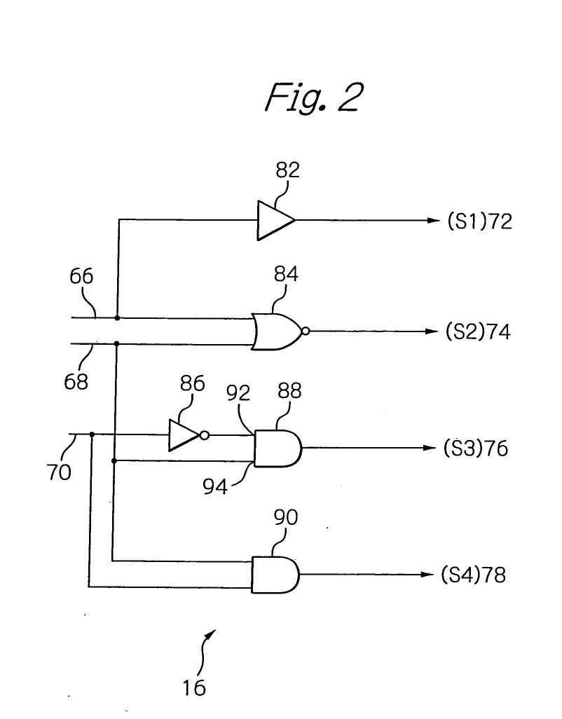

In order to generate the switch signals 72 to 78, the switch control signal generator 16 of the instant illustrative embodiment includes, as shown in FIG. 2, a buffer 82, a NOR gate 84, an inverter 86, and AND gates 88 and 90.

The details of the connection of the switch control signal generator 16 are shown. The load signal 66 is output through the buffer 82. The buffer 82 outputs the load signal 66 as a switch signal (S1) 72. The NOR gate 84 receives the load signals 66 and 68. The NOR gate 84 outputs a signal of level “L” (low) if either one of the load signals 66 and 68 received is at its level “H” (high). The NOR gate 84 outputs an output signal as a switch signal (S2) 74. The inverter 86 inverts the polarity signal 70 and outputs the inverted signal to one input terminal 92 of the AND gate 88. The AND gate 88 receives the load signal 68 at its other input terminal 94. The AND gate 88 outputs a signal of level “H” as a switch signal (S3) 76 only when the polarity signal is at its level “L” and the load signal 68 is at its level “H”. Further, the AND gate 90 receives the load signal 68 and the polarity signal 70. The AND gates 90 outputs a signal of level “H” as a switch signal (S4) 78 only when the polarity signal is at its level “H” and the load signal 68 is at its level “H”.

Referring back to FIG. 1, the switch control signal generator 16 supplies the switch signal 72 to the switches 34 and 38, and the switch signal 74 to the switches 36 and 40. Further, the switch control signal generator 16 supplies the switch signal 76 to the switches 42 and 48, and the switch signal 78 to the switches 44 and 46. The switches 36 to 48 all can be turned on with a positive bias voltage, i.e. rendered active for a positive signal.

So configured, charge sharing between the liquid crystal loads allows the liquid crystal panel to reduce heat generated in the LSI circuitry, although the total amount of electrical power consumed by the liquid crystal panel remains unchanged.

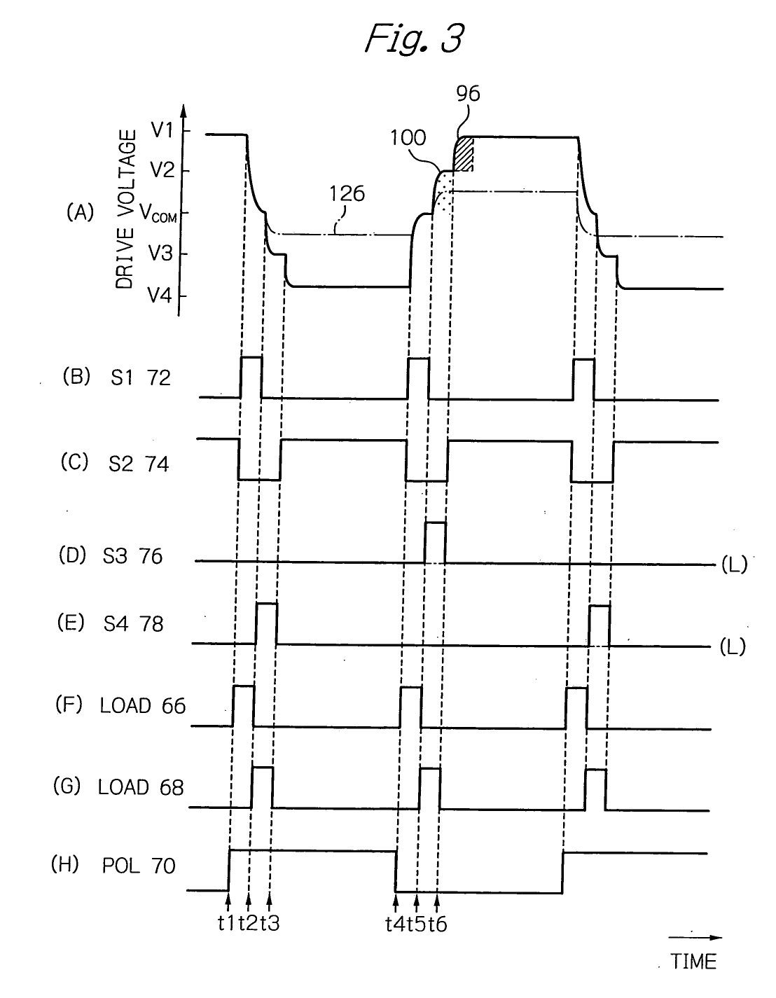

Next, operation of the liquid crystal display driver 10 will be described with reference to FIG. 3. As shown in FIG. 3, part (A), the liquid crystal load on the liquid crystal panel is driven by a voltage in the range between voltages V1 and V4 while charge sharing is effected between the liquid crystal loads in the liquid crystal display driver 10. This driving method uses a dot inversion drive where the polarity of a selection voltage is alternately inversed every horizontal scanning period. The charge sharing technique proposed for the dot inversion drive method is accomplished by providing the switches with electrical signals, as shown in FIG. 3, lines (B) through (E). Further, the switch signals S1 to S4 for control of the switches are generated based on the load signals 66, 68 shown in FIG. 3, lines (F) and (G), and the polarity signal 70.

Detailed operation of the liquid crystal display driver 10 will be described. The output of the operational amplifier 18 in the liquid crystal display driver 10 is in its high state, i.e. close to the voltage V1. At time t1, the switch signal (S1) 72 transitioning from its level “L” to “H” is supplied to the switches 34 and 38. At time t1, the switch signal (S2) 74 transitioning from its level “H” to “L” is supplied to the switches 36 and 40. At time t1, the switch signals (S3) 74 and (S4) 78 of level “L” are supplied to the switches 42 to 48 of the external switcher 32. This causes only the switches 34 and 38 to be in its on-state and short circuited. This short circuit causes the liquid crystal load 54 to be discharged starting at a voltage near the value V1. The output of the liquid crystal display driver 10 is caused to be a liquid crystal common voltage V_{COM}.

Further, although not shown, the output of the operational amplifier 20 is in its low state, i.e. close to the voltage V4. The short circuiting of the switch 38 causes the liquid crystal load 58 to be charged starting at a voltage near the value V4. The output of the liquid crystal display driver 10 is caused to be the liquid crystal common voltage V_{COM}.

Then, at time t2, the switch signal (S1) 72 transitioning from its level “H” to “L” is supplied to the switches 34 and 38. This causes the switches 34 and 38 to be turned off. Even at this point, the switches 36 and 40 are still in its off-state. Therefore, the output of the liquid crystal display driver 10 is still at the liquid crystal common voltage V_{COM}. The output of the liquid crystal display driver 10 is preferably reduced from the liquid crystal common voltage V_{COM} to a voltage near the value V4.

At time t2, the switch signal (S4) 78 transitions from its level “L” to “H”. This causes the switches 44 and 46 to be turned on. At this point, the external switcher 32 begins to operate. Specifically, the switch 44 is rendered conductive and thus the liquid crystal display driver 10 switches over to use the external power supply, which in turn causes the voltage at the terminal 50 of the liquid crystal panel to be reduced to the voltage V3. Also, although not shown in FIG. 3, part (A), the switch 46 is conducted and thus the liquid crystal display driver 10 switches over to use the external power supply, which causes the voltage at the terminal 52 of the liquid crystal panel to be increased to the voltage V2 and charges the liquid crystal load. Electrical power is consumed by the external power supply and thus the LSI does not generate heat.

Further, at time t3, the switch signal (S2) 74 transitions from level “L” to “H” and the switch signal (S4) 78 transitions from the level “H” to “L”. This transition at time t3 causes the switches 36 and 40 to be turned on, and the switches 44 and 46 to be turned off. At this point, in the liquid crystal display driver 10, the operational amplifier 18 outputs an expected value of voltage corresponding to the gray scale signal 22. As shown in FIG. 3, part (A), the operational amplifier 18 supplies its output through the internal switcher 28 and reduces the voltage at the terminal 50 from the voltage V3 to the voltage V4. Further, although not shown, the operational amplifier 20 also outputs an expected value of voltage corresponding to the gray scale signal 22, for example, a voltage near the value V1. The LSI circuitry including the operational amplifiers 18 and 20 consumes electrical power substantially only during the conduction of the switches 36 and 40.

Further, at time t4, in the internal switcher 28, the switches 34 and 38 are turned on, and the switches 36 and 40 are turned off. The switches 42 to 48 within the external switcher 32 are all in the off-state thereof. With regard to the terminal 50 of the liquid crystal panel, the voltage is equal to the value V4 just before time t4, as shown in FIG. 3, part (A). The conduction of the switch 34 causes the voltage at the terminal 50 to be increased to the liquid crystal common voltage V_{COM}. Further, with regard to the terminal 52 of the liquid crystal panel, the voltage is equal to the value V1 immediately before time t4. The conduction of the switch 38 causes the voltage at the terminal 52 to be reduced to the liquid crystal common voltage V_{COM}.

Further, at time t5, the switch signal S3 of level “H” is supplied to the switch 42 and the voltage V2 supplied from the external power supply is applied to the terminal 50, and more specifically, the voltage at the terminal 50 is increased to the voltage V2 to charge the liquid crystal load 54. Further, the switch signal S3 of level “H” is supplied to the switch 48 and the voltage V3 supplied from the external power supply is applied to the terminal 58, i.e. the voltage at the terminal 58 is reduced to the voltage V3.

At time t6, the switch signal S2 is again raised to its level “H” and the switches 36 and 40 are turned on. At this point, the switches 34 and 38, and the switches 42 to 48 in the external switcher 32 are all in their off-state. Accordingly, as shown in FIG. 3, part (A), the operational amplifier 18 causes the voltage at the terminal 50 to be increased to a voltage near the value V1 or to an expected value of voltage corresponding to a gray scale or gradation signal, i.e. the liquid crystal load 54 is charged. Further, although not shown, the operational amplifier 20 causes the voltage at the terminal 52 to be reduced to a voltage near the value V4 or to an expected value of voltage corresponding to a gray scale signal, i.e. the liquid crystal load 58 is discharged.

In summary, in a method for driving a liquid crystal panel, an internal power supply is provided for supplying a voltage in the range between the voltages v1 and V4, and an external power supply, not shown, is provided in an area separate from the internal power supply. The internal and external power supplies provide power to liquid crystal loads. The internal power supply applies a voltage in the range between voltages v1 and V4, and the external power supply applies voltages V2 and V3 given with reference to the liquid crystal common voltage V_{COM} set in the range between voltages V1 and V4. When voltages are supplied to the liquid crystal loads, switch control signals 72 to 78 are generated so that the liquid crystal load is charged or discharged depending on whether the voltage of the liquid crystal load with reference to V_{COM} is in predetermined ranges, i.e. in the range of between the values V2 and V_{COM}, or in the range of between the values V_{COM} and V3, or out of the predetermined ranges, i.e. in the range of between the values V1 and V2, or in the range of between the values V3 and V4. In response to the switch control signals 72 to 78, voltages are supplied from the external power supply if the voltage of the liquid crystal load is in the predetermined range, whereas voltages are supplied from the internal power supply if the voltage of the liquid crystal load is out of the predetermined range. In this way, the method involves selecting either one of the internal and external power supplies, and allowing the selected power supply to provide charge to the display loads, thus limiting the amount of electrical power drawn from the driver 12.

Since the liquid crystal display driver is operated in the manner as described above, a period during which electrical power is consumed by the operational amplifiers 18 and 20 is only a part of the scanning period of an image signal. In other words, only one of the two power supplies is used during a part of the scanning period. This means that in the instant illustrative embodiment, a pre-charge period for charging a liquid crystal load with voltages measured with reference to the liquid crystal common voltage V_{COM} is divided into two sub-periods, with the first sub-period required for the first voltage to be supplied by the external power supply and the second sub-period required for the second voltage to be supplied by the internal power supply. Accordingly, electrical power consumed by the internal power supply fabricated on the LSI chip can be reduced. This reduces heat generated in the LSI package.

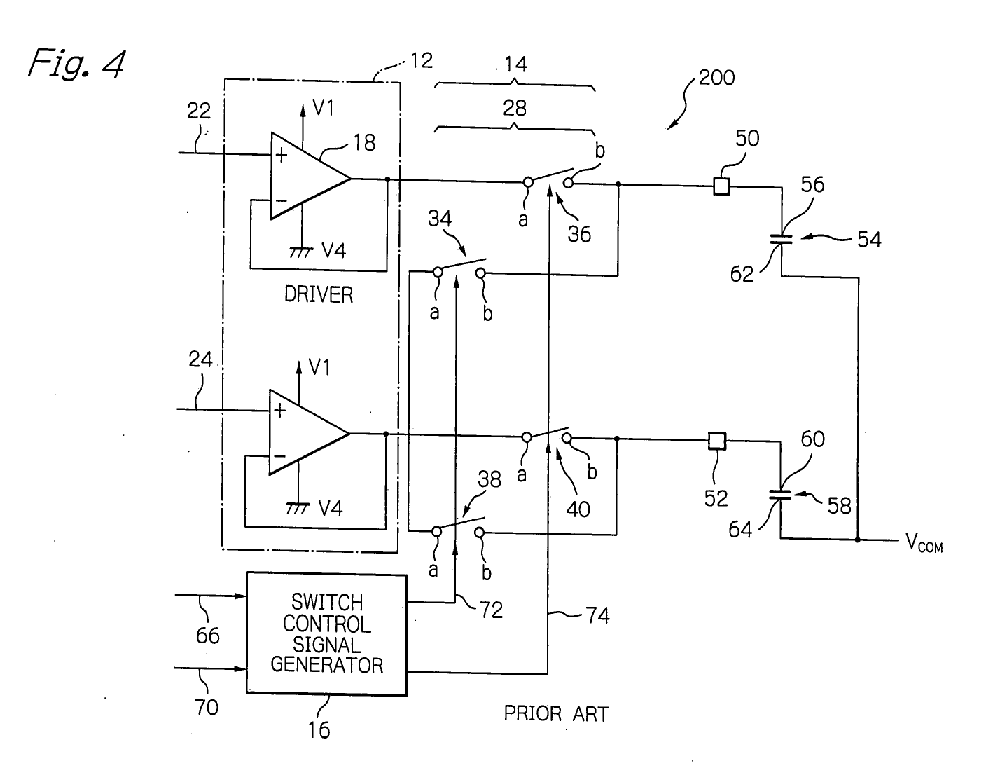

Next, comparison with a conventional liquid crystal display driver 200 will be presented. Reference numerals may be given to like elements and a detailed description thereon will not be repeated. As shown in FIG. 4, the liquid crystal display driver 200 includes the driver 12, drive switcher 14, and switching control signal generator 16. The drive switcher 14 has however only the internal switcher 28 and has no external switcher corresponding to the switcher 32 described earlier. The drive switcher 14 includes the buffer 82 and NOR gate 84 shown in FIG. 2. The NOR gate 84 receives the load signal 66 on its one end and the polarity signal 70 at its other end.

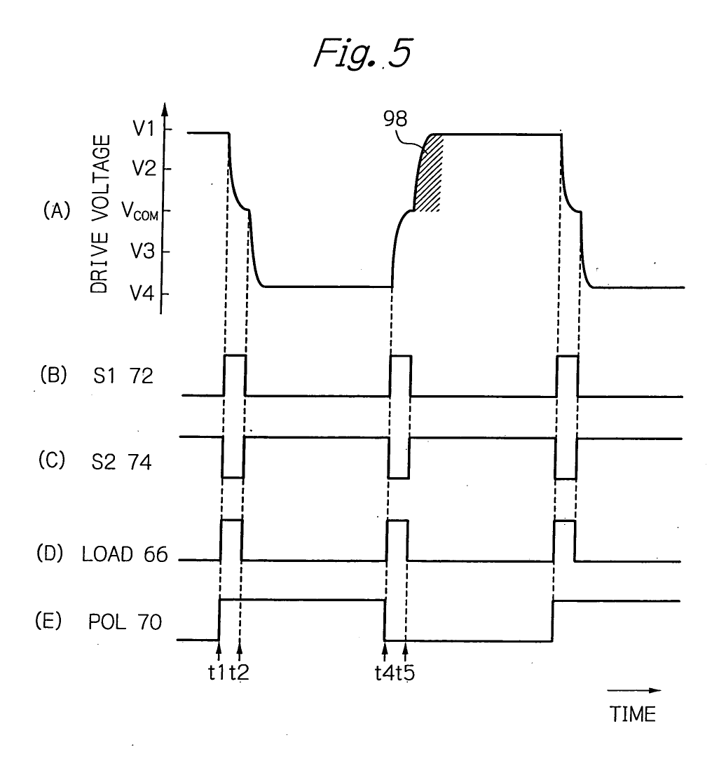

Operation of the liquid crystal display driver 200 will be described with reference to FIG. 5. At time t1, the switch signal S1 (72) of level “H” is supplied to the switches 34 and 38, and the switch signal S2 (74) of level “L” is supplied to the switches 36 and 40. This causes the voltage at the terminal 50 of the liquid crystal panel to be reduced to the liquid crystal common voltage V_{COM}. At time t2, the switch signal S1 (72) of level “L” is supplied to the switches 34 and 38, and the switch signal S2 (74) of level “H” is supplied to the switches 36 and 40. The operational amplifier 18 causes the voltage at the terminal 50 of the liquid crystal display driver 10 to be reduced from the liquid crystal common voltage V_{COM} to a voltage near the expected value of voltage V4. At this point, electrical power consumed by the operational amplifier 18 is low.

Further at time t4, the switch signal S1 (72) of level “H” is again supplied to the switches 34 and 38, and the switch signal S2 (74) of level “L” is supplied to the switches 36 and 40. This causes the voltage at the terminal 50 of the liquid crystal panel to be increased to the liquid crystal common voltage V_{COM}. At time t5, the switch signal S1 (72) of level “L” is supplied to the switches 34 and 38, and the switch signal S2 (74) of level “H” is supplied to the switches 36 and 40. The operational amplifier 18 causes the voltage at the terminal 50 of the liquid crystal panel to be increased from the liquid crystal common voltage V_{COM} to a voltage near the expected value of voltage V1 to charge the liquid crystal load. This charging results in the operational amplifier 18 consuming electrical power. In this way, charge sharing takes place between the liquid crystal loads and thus the liquid crystal display driver 200 causes the liquid crystal panel to reduce power consumption by a factor of one half.

Note that the total amount of power consumed by the liquid crystal panel is substantially the same between the cases of the liquid crystal display drivers 10 and 200. Most of the electrical power is consumed during charging. Comparison is made on the amount of electrical power consumed by the LSI devices during charging between the liquid crystal display drivers 10 and 200. The result is that the area 96 indicated in FIG. 3, part (A), is obviously smaller than the area 98 indicated in FIG. 5, part (A). That is, in accordance with the invention, electrical power consumed by the LSI circuitry in the liquid crystal display driver 10 is lower. Further, the area 100 indicated in FIG. 3, part (A), corresponds to the amount of electrical charge creating current delivered from the external power supply, i.e. the amount of power consumption. The electrical power consumed does not add heat to the LSI package, and thus the liquid crystal display driver 10 in accordance with the invention can significantly reduce heat generation, as compared to the case of the liquid crystal display driver 200.

Charge sharing takes place between the liquid crystal loads, and thus driving the liquid crystal panel by the liquid crystal display driver 200 gives twice the slew rate of the operational amplifier as used in a driver using no charge sharing method. Further, during a period other than a pre-charge period during which the internal power supply is used, the liquid crystal display driver 10 in accordance with the invention can drive the liquid crystal load faster than the liquid crystal display driver 200 using the internal power supply only, because the two-step pre-charging method using the external power supply is carried out.

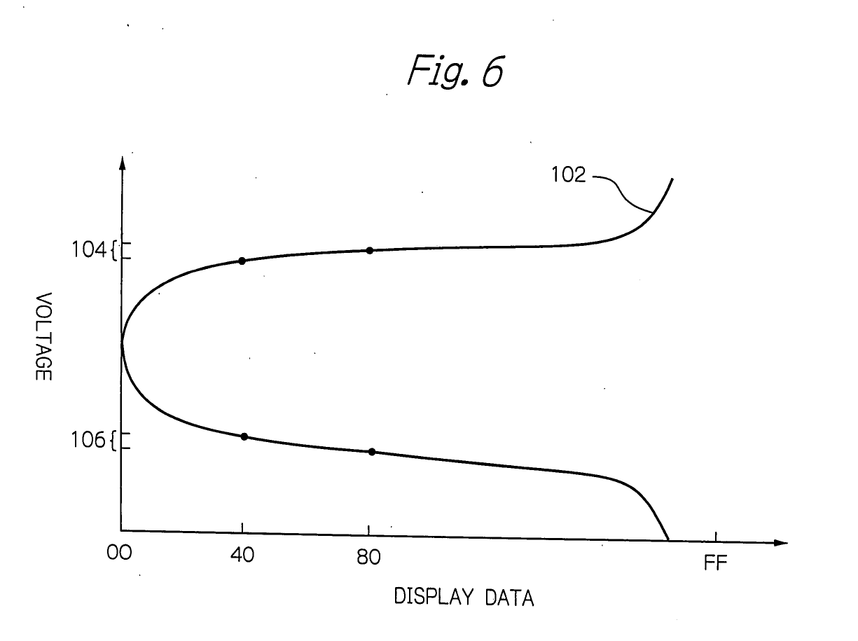

Note that the liquid crystal display driver 10 of the illustrative embodiment benefits from a two-step pre-charging method where the external power supply is used to discharge and charge the liquid crystal load during a period other than a pre-charge period during which the internal power supply is used. The voltages V2 and V3 to be output from the external power supply during the pre-charge period are preferably determined depending on gray-scale values of an image. As shown in FIG. 6, gray scale or gradation data representing an image is data to be displayed, and represented by a gamma curve 102. The gamma curve 102 is associated with voltage. The voltages V2 and V3 are preferably set in a range of “40” to “80” where the gamma curve corresponding to gradation data is in hexadecimal notation. Accordingly, as seen from FIG. 6, voltage ranges 104 and 106 are selected so as to correspond to the data range of “40” to “80”.

The liquid crystal display driver 10, in general term, is a drive device for outputting voltages corresponding to a plurality (n) of gradation steps developing from the lowest to the highest gray-scale level, and the external power supply is preferably designed to supply voltages corresponding to the gradation levels from “n/4” to “n/2”. The external power supply can be designed to supply voltages corresponding to the gradation levels from “n/4” to “3n/4”. However, if too much electrical charge flowing from the external power supply during the pre-charge period is present on the liquid crystal load, the driver 10 is required to drain off the electrical charge accumulated on the liquid crystal load. This means electrical power is wasted. In practice, it is preferred that the voltages are determined so as to correspond to the gradation levels of “n/4” to “n/2”.

Further, while the liquid crystal display driver 10 of the embodiment has been described as benefiting from the two-step pre-charge method where the external power supply is used to discharge and charge the liquid crystal load, the number of the steps of discharging and charging is not limited to two, but may be three or more depending on the characteristics, etc., of an image to be displayed.

If so configured, the terminal of the liquid crystal load is first pulled up to the intermediate voltage V2 by the external power supply and thus the operational amplifiers 18 and 20 in the driver 12 may only charge the liquid crystal load to half of the conventional charge voltage V1. Even in such a case, the positive- and negative-going characteristics of the voltage at the terminal are substantially equal to that in the case of charging the liquid crystal load to full of the charging voltage V1.

Further, when the liquid crystal display drivers 10 and 200 use substantially the same driver as the driver 12, the liquid crystal display driver 10 can operate faster than the conventional liquid crystal display driver 200. Heat is generated whenever current flows. More specifically, in the conventional liquid crystal display driver 200, charging current to the liquid crystal load flows from the voltage V1 to the voltage V4, whereas in the liquid crystal display driver 10, a part of charging current to the liquid crystal load flows from the voltage V2 to the voltage V3. This means that electrical power consumed by the LSI is reduced by the amount of electrical power supplied by the external power supply, and the amount of heat generated by the LSI is reduced to about one half of that in the conventional liquid crystal display driver. Accordingly, the liquid crystal display driver 10 can be used at a temperature below the allowable, maximum operational temperature.

It is needless to say, although the liquid crystal display driver 10 of the embodiment has been described as including the switches 34 to 48, the driver 10 may include, instead of those switches, an on/off circuit or device using a low resistive element whose resistance is rendered low in its conduction mode.

Further, the liquid crystal display driver 10 includes the switching control signal generator 16 for preventing unnecessary power consumption. The switching control signal generator 16 may be provided with the capability of analyzing digital data. The capability of analyzing digital data is implemented by determining whether or not the most significant bit position of the gray-scale data has a predetermined binary value to determine whether or not to carry out charging with voltages V2 and V3.

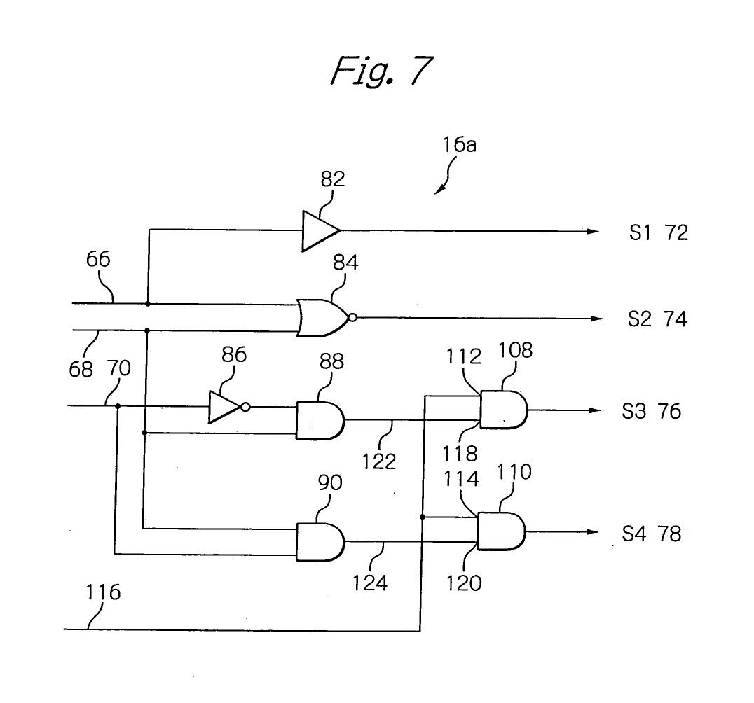

The switching control signal generator 16a shown in FIG. 7 includes AND gates 108 and 110 in addition to the elements shown in FIG. 2. The most significant bit 116 of gray-scale data is supplied to one input terminal 112 of the AND gate 108 and one input terminal 114 of the AND gate 110. Further, an output signal 122 of the AND gate 88 is supplied to the other input terminal 118 of the AND gate 108. An output signal 124 of the AND gate 90 is supplied to the other input terminal 114 of the AND gate 110. The AND gates 108 and 110 output an output signal depending on whether or not the most significant bit has the predetermined value, “H” in this example. If the most significant bit is of the predetermined value “H”, a signal of level “H” is output. Otherwise, a signal of level “L” is output.

Referring back to FIG. 3, lines (D) and (E), if the most significant bit is of the predetermined value “H”, then the significant switch signals S3 and S4 appear on the output ports of the gates 108 and 110. Thus, the driver 10, when including the switching control signal generator 16a, FIG. 7, operates in the same way as the previously described embodiment.

By contrast, if the most significant bit does not include the predetermined binary value, then the levels of the signals S3 and S4 are always “L”. This causes the external switcher 32 to be always in its off-state after time t2. In this case, the liquid crystal display driver 10 reduces unnecessary electrical power waste, and, for example, depending on gray-scale data, prevents a voltage drop on the terminal of the liquid crystal load from exceeding a difference between the voltage V1 and a level denoted by a dot-and-dash line 126 in FIG. 3, part (A). The liquid crystal display driver 10 begins charging at time t4 and increases a drive voltage to the liquid crystal common voltage V_{COM}. Then, the operational amplifier 18 of the driver 12 increases its output voltage to a voltage corresponding to gray-scale data and optimizes electrical power consumption.

In this way, the liquid crystal display driver 10 determines whether or not the external power supply is used to pre-charge the liquid crystal load depending on whether or not the most significant bit takes its significant value, and operates the external power supply accordingly, thereby driving the liquid crystal load while reducing unnecessary electrical power waste.

The entire disclosure of Japanese patent application No. 2006-15482 filed on Jan. 24, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A driving apparatus operative in response to gray-scale data supplied for driving display loads corresponding to pixels, comprising:
a first driver connected to a first power supply for providing a predetermined range of voltages and receiving a gray-scale signal corresponding to the gray-scale data, said first driver applying a voltage corresponding to the gray-scale data to the display load to drive the display load;
a second driver acting as a second power supply for applying a plurality of voltages selected appropriately from the predetermined range of voltages to the display load to drive the display load;
a switcher for switching between first drive supported by said first driver and second drive supported by said second driver; and
a switching controller for generating a switch signal selecting either one of the first and second drives;
said second power supply being provided outside a position at which said first power supply is located.

2. The apparatus in accordance with claim 1, wherein said apparatus is contained in a package, said second power supply being provided outside the package.

3. The apparatus in accordance with claim 1, wherein said switching controller generates the switch signal based on a load signal corresponding to a number of the voltages supplied by said second power supply and a signal representative of polarity.

4. The apparatus in accordance with claim 1, wherein said switching controller includes a deciding circuit for determining whether or not the second driver is usable.

5. The apparatus in accordance with claim 1, wherein said apparatus outputs the voltages corresponding to a plurality of gradation levels developing from a lowest value to a highest value, said second power supply supplying the voltages corresponding to the gradation level of one-fourth of the plurality to the gradation of half of the plurality.

6. A method for driving display loads corresponding to pixels in response to gray-scale data supplied, comprising the steps of:
supplying the display loads with a voltage in a predetermined range of voltages from a first power supply providing a voltage in the predetermined range of voltages;
supplying the display loads with a plurality of voltages selected appropriately from the predetermined range of voltages from a second power supply provided outside a position at which the first power supply is located;
generating, when a voltage is applied to the display load, a switch control signal for discharging or charging the display load depending on whether the voltage is within or outside the selected plurality of voltages; and
supplying, if the voltage is within the selected plurality of voltages, an electric power from the second power supply, and if the voltage is outside the selected plurality of voltages, the electric power from the first power supply.

7. The method in accordance with claim 6, further comprising a step of determining whether or not to provide the electric power from the second power supply depending on whether or not a most significant bit of the gray-scale data is of a predetermined value.
